(19) United States
(12) Patent Application Publication
(10) Pub. No.: US 2008/0258328 A1
(43) Pub. Date: Oct. 23, 2008

(54) Process for Producing Cylindrical Mouldings Based on Cellular Polyurethane Elastomers

(75) Inventors: Ralf Hansen, Osnabrueck (DE); Peter Jackisch, Weyhe-Kirchweyhe (DE); Elke Marten, Ostercappeln (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/816,313

(22) PCT Filed: Feb. 21, 2006
(86) PCT No.: PCT/EP06/60146

§ 371 Date: Aug. 15, 2007

(30) Foreign Application Priority Data
Feb. 22, 2005 (DE) 10 2005 008 263.7

(51) Int. Cl. C08J 9/06

(52) U.S. Cl. 264/54

(57) ABSTRACT

A process for the production of cylindrical moldings based on cellular polyurethane elastomers having a density, according to DIN EN ISO 1798, of from 350 to 800 kg/m³, a tensile strength, according to DIN EN ISO 1798, of ≧2.0 N/mm², an elongation, according to DIN EN ISO 1798, of ≧200% and a tear propagation resistance, according to DIN ISO 34-1 B, of ≧8 N/mm by reacting a prepolymer (i) having isocyanate groups with a crosslinking component (ii) in a mold, wherein the prepolymer (i) having isocyanate groups is based on methylenediphenyl diisocyanate (MDI) and (b1) polyetherdiol having a molecular weight of from 1500 g/mol to 3000 g/mol and based on propylene oxide and/or ethylene oxide, and the crosslinking component (ii) comprises (b2) polyetheralcohol having a nominal functionality with respect to isocyanates of from 2 to 3 and a molecular weight of from 1500 g/mol to 6000 g/mol and based on propylene oxide and/or ethylene oxide, and (c2) diol having a molecular weight of from 62 g/mol to 499 g/mol, (d) water and (e) catalysts, and the prepolymer (i) and the crosslinking component (ii) are introduced into the mold by means of a high pressure machine which has a mixing head in which the components (i) and (ii) are mixed, the mixing head output being from 15 to 60 g/s.

The invention relates to a process for the production of cylindrical, preferably hollow moldings, in particular hollow cylindrical automobile overload springs preferably for motor vehicle shock absorbers, particularly preferably motor vehicle shock absorbers comprising hollow cylindrical automobile overload springs based on cellular polyurethane elastomers which, if appropriate, may comprise isocyanurate and/or urea structures, having a density, according to DIN EN ISO 845, of from 300 to 900 kg/m³, a tensile strength, according to DIN EN ISO 1798, of ≧2.0 N/mm², preferably ≧2.5 N/mm², an elongation at break, according to DIN EN ISO 1798, of ≧200%, preferably ≧350%, and a tear propagation resistance, according to DIN ISO 34-1 B (b), of ≧8 N/mm and particularly preferably a compression set (at 70° C., 40% deformation, 22 hours), based on DIN EN ISO 1856, of less than 20%, by reacting a prepolymer (i) having isocyanate groups with a crosslinking component (ii) in a mold.

Overload springs which are pushed onto the piston rod of the shock absorber in automobiles, for example within the total suspension strut construction, consisting of shock absorber, coil spring and the elastomer spring, are generally known in automotive construction and are based on cellular, for example microcellular polyisocyanate polyadducts, usually polyurethanes and/or polyisocyanurates, which, if appropriate, may comprise urea structures and are obtainable by reacting isocyanates with compounds reactive toward isocyanates.

These particular products differ substantially in their range of requirements from conventional polyurethane foams and usually have a substantially higher density of, usually, from 300 to 900 kg/m³ and particular physical properties.

In use, these overload springs are subjected to considerable loads over a very long life. It is necessary for the overload springs to have a performance profile which is as constant as possible over the life of the automobile.

For example, a compression set which is as low as possible in combination with low water absorption may be mentioned as particular requirements. In addition, components comprising microcellular polyurethane elastomers and used as overload springs are in some cases exposed to elevated temperatures in combination with moisture and the influence of microbes. For this reason, the best possible stability to hydrolysis of the materials is to be strived for so that they can meet the high mechanical requirements over as long a period as possible. Temperatures below the glass transition temperature of the cellular polyurethane elastomer lead to loss of the elastic properties of the component. For special applications, it is therefore desirable further to improve the low-temperature flexibility of the cellular polyurethane elastomers without adversely affecting the good static and dynamic properties of these materials.

Further requirements with regard to the cellular polyisocyanate polyadducts consist in the achievement of excellent dynamic mechanical and static mechanical properties, for example of outstanding tensile strengths, elongations, tear propagation resistances and compression sets, so that in particular the polyurethane elastomers can fulfill over as long a period as possible the high mechanical requirements which the damping elements have to meet.

DE-A 36 13 650 and EP-A 178 562 describe the preparation of resilient, compact or cellular polyurethane elastomers. The polyetheresterdiols used as a polyol component and prepared from polyoxytetramethylene glycols having molecular weights of from 162 to 10 000 and organic dicarboxylic acids lead to improved stabilities of the polyurethane elastomers to hydrolysis compared with the use of pure polyesterpolyols. However, a disadvantage is the high price of the polyetheresterpolyols according to the invention. Regarding the low-temperature flexibility of the polyurethane elastomers prepared according to the invention, no information is given in either of the two patents.

It is generally known that MDI-based and hence economical cellular PU elastomers can be used for damping element applications in the automobile (WO 96/11219). In order to achieve the best possible mechanical properties, polyesterols are usually used as a flexible phase, which results in a low stability to hydrolysis in a hot, humid climate (≧80° C.). Particularly in the case of damping elements in automotive applications, temperatures above 80° C. are reached as a result of the dynamic load. At these elevated temperatures, the stability of the foams to hydrolysis represents a particular challenge.

It was therefore an object of the invention to provide a process for the production of cylindrical, preferably hollow moldings, in particular overload springs which are used in automobile chasses on piston rods of the shock absorber, which moldings are distinguished by a low water absorption, a low compression set, a very fine cell structure and good dynamic and mechanical properties, it being intended in particular that the high level of tensile strength and elongation at break be retained at as high a level as possible even under humid warm conditions. The moldings, in particular the overload springs, should be capable of being economically processed.

The products of the present invention, i.e. in particular the overload springs according to the invention, are generally known and widely used. The production of these moldings in corresponding molds has been widely described and is generally known to the person skilled in the art, for example from DE-C 44 38 143. It is precisely the abovementioned problems that are of particular importance in the area of overload springs, owing to the special form, which usually has a cavity in which the piston rod of the automobile shock absorber is placed, and the extreme long-term load in the automobile chassis.

The above objects could be achieved if the prepolymer (i) having isocyanate groups and preferably having an NCO content of from 1% by weight to 30% by weight, particularly preferably from 6% by weight to 20% by weight, in particular from 13 to 20% by weight, particularly preferably from 14% by weight to 20% by weight, is based on methylenediphenyl diisocyanate (MDI) and (b1) polyetherdiol having a molecular weight of from 1500 g/mol to 3000 g/mol and based on propylene oxide and/or ethylene oxide, and the crosslinking component (ii) comprises polyetheralcohol (b2) having a nominal functionality with respect to isocyanates of from 2 to 3 and a molecular weight of from 1500 g/mol to 6000 g/mol and based on propylene oxide and/or ethylene oxide, and diol (c2) having a molecular weight of from 62 g/mol to 499 g/mol, preferably butane-1,4-diol and/or ethylene glycol, water (d) and catalysts (e), and the prepolymer (i) and the crosslinking component (ii) are introduced into the mold by means of a high pressure machine which has a mixing head in which the components (i) and (ii) are mixed, the mixing head output being from 15 to 60 g/s.

In using the high pressure technology according to the invention, it was possible to produce a very fine-celled foam, particularly taking into account the preferred process parameters.

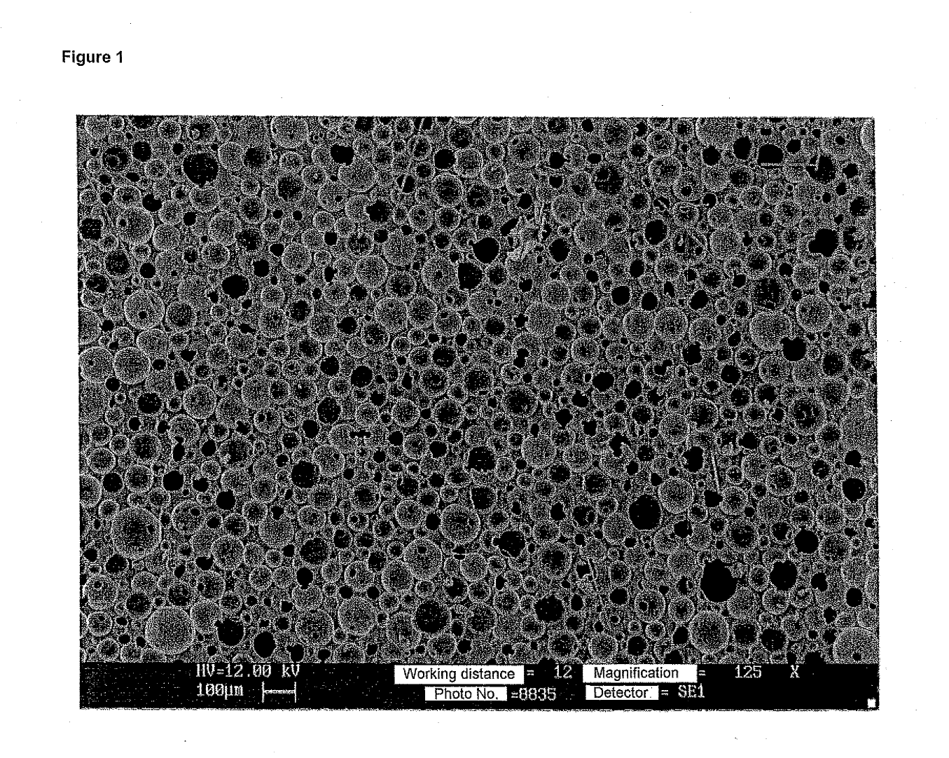

FIG. 1 shows a scanning electron micrograph of a foam which was produced by means of a high pressure machine.

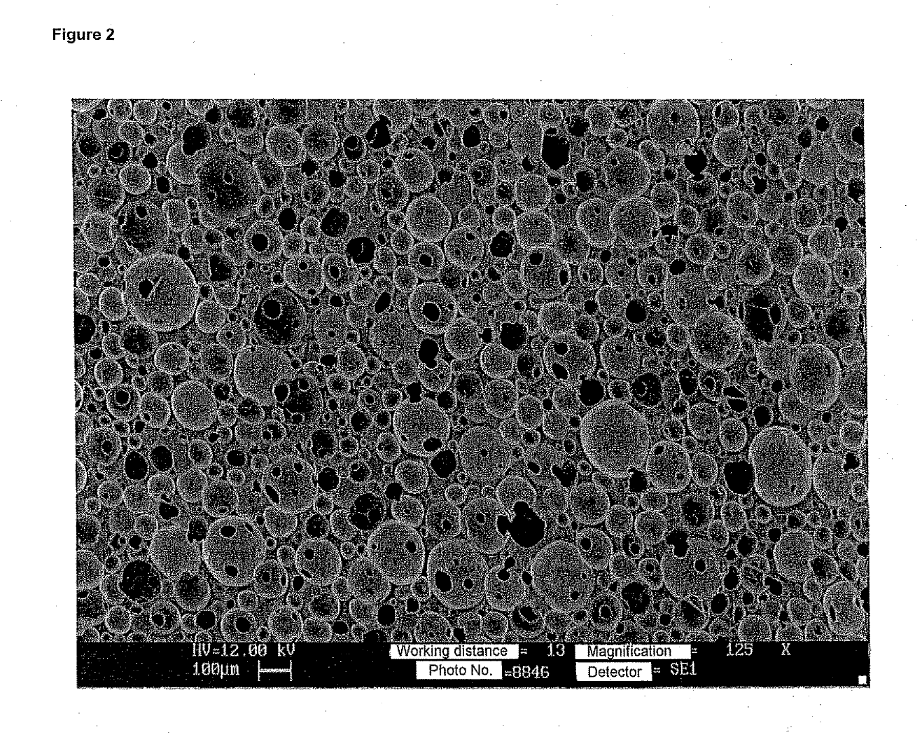

FIG. 2 shows the scanning electron micrograph of a foam which was produced by means of a low pressure machine. The difference in the cell structure is clearly visible. With the high pressure machine, it was possible to achieve a cell density of 204 cells/mm². In contrast, only 140 cells/mm² were achieved using the low pressure machine.

In addition, the use of the high pressure machines leads to moldings having better physical properties, in particular improved compression sets. Compression sets of 58% could be achieved here using the high pressure technology, whereas only compression sets of 75-80% were achieved in the case of the low pressure technology.

The compression set was measured at 80° C. using a modification of DIN 53 572 with the use of 18 mm high spacers and test specimens having a base area of 40×40 mm and a height of 30±1 mm. The compression set (CS) was calculated according to the equation

CS=[(H₀−H₂)/(H₀−H₁)]·100[%]

where
H₀ is the original height of the test specimen in mm,
H₁ is the height of the test specimen in the deformed state in mm,
H₂ is the height of the test specimen after relief in mm.

Furthermore, the high pressure technology has the advantage that components having a low density of, for example, 400 g/l are still foamed. In the low pressure technology, components having a density of less than 450 g/l are obtainable only with difficulty. This applies in particular to long slim cylindrical moldings. In addition to the real components, this effect can also be observed in cup foams which are produced by free-rise foaming and are produced as a reference for the foam rise behavior according to fixed parameters. In the high pressure technology, a maximum cup foam height of 170 mm is reached, whereas only 160 mm are reached in the low pressure technology.

The components (i) and (ii) preferably have a temperature of from 25° C. to 60° C. in each case in the mixing head.

The mixing head outflow temperature, i.e. the temperature of the mixed components (i) and (ii), is preferably from 40° C. to 60° C.

The inner surface of the mold preferably has a temperature of from 40° C. to 90° C. This leads to a substantially lower water absorption of the molding.

The high pressure machine preferably has an operating pressure, in particular a pressure at which the components (i) and (ii) are pressed into the mixing head, of from 140 to 200 bar.

In addition to the optimization with regard to process engineering, the raw materials were also adapted and improved in a specific manner in the present invention.

By the choice of the isocyanate, i.e. of the MDI, and a polyetherdiol based on ethylene oxide and/or propylene oxide, it was possible, in addition to optimization of the property profile described at the outset, also to realize particularly advantageous, low raw material costs. The desired spring temper can be achieved by a preferred hard segment fraction of from 30 to 50% by weight. The calculation of the hard segment fraction (% HS) is performed by assuming complete conversion of the polyurethane-forming reactants and complete CO₂ exchange according to the following equation:

$$\% HS = \frac{\begin{matrix}( {m}_{MDI} + {m}_{C 1} ) \cdot {W}_{p} + \\ ( {m}_{C 2} ) \cdot {W}_{V} - ( {m}_{H 2 O} \cdot {W}_{V} \cdot 44 / 18 )\end{matrix}}{( {m}_{MDI} + {m}_{C 1} + {m}_{b 1} ) \cdot {W}_{p} + ( {m}_{C 2} + {m}_{H 2 O} + {m}_{b 2} ) \cdot {W}_{V}} \cdot 100$$

% HS: Mass fraction of hard segment in the cylindrical molding in % by weight
m_{MDI}: Mass fraction of MDI (a) in the prepolymer (i) in gig
m_{C1}: Mass fraction of chain extender (c1) in the prepolymer (i) in g/g
W_{P}: Mass fraction of the prepolymer (i) in the cylindrical molding, i.e. based on the total mass of prepolymer (i) and crosslinking component (ii), in gig
m_{C2}: Mass fraction of chain extender (c2) in the crosslinking component (ii) in g/9
m_{H2O}: Mass fraction of water in the crosslinking component (ii) in g/g
W_{V}: Mass fraction of the crosslinking component (ii) in the cylindrical molding, i.e. based on the total mass of prepolymer (i) and crosslinking component (ii), in gig
m_{b1}: Mass fraction of polyol b1 in the prepolymer (i) in g/g
M_{b2}: Mass fraction of polyol b2 in the crosslinking component (ii) in g/g

It may be of particular advantage precisely for the production of the moldings according to the invention, in particular of the overload springs, if the cylindrical moldings are annealed, i.e. heated, at a temperature of from 80° C. to 130° C. for a duration of from 3 to 48 hours after removal from the mold. As a result, the compression set based on DIN EN ISO 1856 (at 70° C., 40% deformation, 22 hours) can be reduced.

The production of the shaped articles is preferably carried out at an NCO/OH ratio of from 0.85 to 1.2 (=index). The heated starting components are preferably mixed and are introduced into a heated, preferably tightly closing mold in an amount corresponding to the desired density of the shaped article.

The shaped articles have usually cured after from 5 to 20 minutes and can therefore be removed from the mold.

The amount of the reaction mixture introduced into the mold is preferably such that the moldings obtained have the density described above. The cellular polyisocyanate polyadducts obtainable according to the invention preferably have a density, according to DIN EN ISO 845, of from 300 to 900 kg/m³, particularly preferably from 300 to 600 kg/m³.

The degrees of compression for the production of the moldings are preferably from 1.1 to 5, preferably from 1.5 to 3.

In order to improve the demolding of the moldings produced according to the invention, it has proven advantageous to coat the inner surfaces of the mold, at least at the beginning of a production run, with conventional external lubricants, for example with wax-based, or in particular silicone-based, aqueous soap solutions.

The demolding times are on average from 5 to 20 minutes, depending on the size and geometry of the shaped article.

After the production of the shaped articles in the mold, the shaped articles can preferably be annealed for a duration of from 3 to 48 hours at a temperature of from 80° C. to 130° C.

In addition to the optimization in terms of process engineering, i.e. the specified use of the high pressure machine, a further optimization according to the objects described at the outset could be achieved by the polyols according to the invention in the prepolymer component and crosslinking component.

When choosing the polyetherols, the challenge was to select suitable polyols which give a foam which gives a high mechanical level both under standard climatic conditions and in a hot, humid climate and also has good low-temperature properties. Surprisingly, the average polyol molar mass M̅(Polyol) of the polyetherols (b) proved to be the determining quantity. Average polyol molar masses of less than 3900 g/mol gave foams whose tensile strength had decreased only by about 40% (based on the initial value) even after storage for 70 days in water thermostated at 80° C. Foams having an average polyol molar mass above 3900 g/mol gave foams whose tensile strengths decreased substantially more sharply during the abovementioned storage conditions (by more than 60%, based on the initial value). With decreasing polyol molar mass, the low-temperature properties generally deteriorate. For the foams according to the invention, comparatively good bow-temperature properties were measured (maximum of the loss modulus G″ₘₐₓ=−53° C., 1 Hz measuring frequency, heating rate 2° C./min, ISO 6721-7).

The process according to the invention for the production of the moldings according to the invention is therefore preferably effected by a procedure in which, in a mold,
(i) a prepolymer having isocyanate groups, preferably having an NCO content of from 1% by weight to 30% by weight, particularly preferably from 6% by weight to 20% by weight, in particular from 13% by weight to 20% by weight, particularly preferably from 14 to 20% by weight, and based on (a) diisocyanatodiphenylmethane (MDI) and
   (b1) at least one polyetherdiol having a molecular weight of from 1500 g/mol to 3000 g/mol and based on ethylene oxide and/or propylene oxide
      is reacted with
(ii) a crosslinking component comprising
   (b2) polyetheralcohols having a nominal functionality with respect to isocyanates of from 2 to 3 and a molecular weight of from 1500 g/mol to 6000 g/mol and based on ethylene oxide and/or propylene oxide,
   (c2) diol having a molecular weight of from 62 g/mol to 499 g/mol, preferably butane-1,4-diol and/or ethylene glycol, (d) water and (e) catalysts,
      the polyols (b) present in the cylindrical, preferably hollow molding and comprising (b1) and (b2) and, if appropriate, further polyols (b), preferably the polyols (b1) and (b2), having an average polyol molar mass of less than 3900 g/mol, preferably from 2000 g/mol to 3800 g/mol, particularly preferably from 3000 g/mol to 3700 g/mol, the average polyol molar mass M̅(Polyol) being calculated according to the following formula:

$$\overline{M} ( Polyol ) = \frac{\begin{matrix}( {M}_{b 11} \cdot {m}_{b 11} + … + {M}_{b 1 n} \cdot {m}_{b 1 n} ) \cdot {W}_{p} + \\ ( {M}_{b 21} \cdot {m}_{b 21} + … + {M}_{b 2 n} \cdot {m}_{b 2 n} ) \cdot {W}_{V}\end{matrix}}{( {m}_{b 11} + … + {m}_{b 1 n} ) \cdot {W}_{p} + ( {m}_{b 21} + … + {m}_{b 2 n} ) \cdot {W}_{V}}$$

where:
M̅(Polyol): Average polyol molar mass, in particular average polyol molar mass of the polyols (b) present in the moldings and comprising (b1) and (b2) and, if appropriate, further polyols (b), in particular average polyol molar mass of the polyetherols (b1) and (b2), in g/mol
M_{b11} (or M_{b1n}): Molar mass of polyol b11 (or polyol b1n) in the prepolymer (i) in g/mol
m_{b11} (or m_{b1n}): Mass fraction of polyol b11 (or polyol b1n) in the prepolymer (i) in g/g
W_{P}: Mass fraction of the prepolymer (i) in the cylindrical molding, i.e., based on the total mass of prepolymer (i) and crosslinking component (ii), in gig
M_{b21} (or M_{b2n}): Molar mass of polyol b21 (or polyol b2n) in the crosslinking component (ii) in g/mol
m_{b21} (or m_{b2n}): Mass fraction of polyol b21 (or polyol b2n) in the crosslinking component (ii) in g/g
W_{V}: Mass fraction of the crosslinking component (ii) in the cylindrical molding, i.e. based on the total mass of prepolymer (i) and crosslinking component (ii), in gig.

The molecular weight is preferably the number average molecular weight.

In the process according to the invention, a prepolymer (i) which has isocyanate groups and preferably has the NCO content described at the outset is reacted with a crosslinking component (ii). The crosslinking component comprises the compounds reactive toward isocyanates, i.e. especially (b2) and preferably (c2) chain extenders and/of crosslinking agents and (d) water, (e) catalysts and, if appropriate, further compounds (b) reactive toward isocyanates and, if appropriate, blowing agents (f) and/or assistants (g). These components which are used are described in detail further below.

The prepolymer is based on the reaction of (a) isocyanate, MDI according to the invention and, if appropriate, further isocyanates, preferably exclusively MDI, with (b1) polyetherdiol and preferably the (c1) diol, preferably glycol. If appropriate, further compounds (b) and/or (c) reactive toward isocyanates may be used in addition to (hi) and preferably (c1). The preparation of the prepolymer (i) can preferably be effected by reacting the polyetherdiol as (b1) based on propylene oxide and/or ethylene oxide and, if appropriate, the diol as (c1) with the MDI as (a) in excess, usually at temperatures of from 70° C. to 100° C., preferably from 70° C. to 90° C. The reaction time is tailored to the achievement of the theoretical NCO content.

Initiators alkoxylated by generally known processes with ethylene oxide and/or propylene oxide, preferably diols, for example ethylene glycol, propylene glycol, diethylene glycol, dipropylene glycol, triethylene glycol, tripropylene glycol, butane-1,4-diol or hexane-1,6-diol, particularly preferably propylene glycol, can be used as (b1) polyetherdiol having a molecular weight of from 1500 g/mol to 3000 g/mol and based on propylene oxide and/or ethylene oxide for the preparation of the prepolymers (i). The polyetherdiols can preferably be propoxylated diols, but it is also possible to use ethoxylated diols or mixed polyetherdiols, it being possible for the alkylene oxides to be arranged blockwise or randomly in the polyetherdiol (b1). As also mentioned further below, if appropriate further polyetheralcohols may be used in addition to the polyetherdiols (b1), for example also polyethermonoalcohols which form in the preparation of the polyetherdiols. The average actual functionality of the polyetherdiols (b1) reactive toward isocyanates and used altogether for the preparation of the prepolymer (i) is preferably from 1.8 to 2.0.

Diols may be used as (c1), preferably diethylene glycol, triethylene glycol, dipropylene glycol and/or triethylene glycol, particularly preferably dipropylene glycol and/or tripropylene glycol, in particular tripropylene glycol.

Cylindrical, preferably hollow moldings in which the prepolymer (i) having isocyanate groups is based on the reaction of (a) diisocyanatodiphenylmethane (MDI), (b1) polyetherdiols having a molecular weight of from 1500 g/mol to 3000 g/mol, preferably 2000 g/mol, and based on propylene oxide and/or ethylene oxide and (c1) diol having a molecular weight of from 62 g/mol to 499 g/mol, preferably from 106 g/mol to 499 g/mol, preferably diethylene glycol, triethylene glycol, dipropylene glycol and/or triethylene glycol, particularly preferably dipropylene glycol and/or tripropylene glycol, in particular tripropylene glycol (as chain extender (c1)), are therefore preferred.

The crosslinking component (ii) comprises, according to the invention, (b2) as a compound reactive toward isocyanates. If appropriate, further compounds (b) which are reactive toward isocyanates and are not covered by the definition of (b2) may be present in the crosslinking component (ii) in addition to (b2), provided that the average polyol molar mass according to the invention over all polyols (b) is fulfilled as a whole. Initiators alkoxylated by generally known processes with ethylene oxide and/or propylene oxide, preferably diols and/or triols, for example ethylene glycol, propylene glycol, diethylene glycol, dipropylene glycol, triethylene glycol, tripropylene glycol, butane-1,4-diol, hexane-1,6-diol, glycerol or trimethylolpropane, preferably propylene glycol and glycerol, may be used as (b2) polyetheralcohols having a nominal functionality with respect to isocyanates of from 2 to 3, i.e. preferably having nominally 2 or 3 hydroxyl groups and a molecular weight of from 1500 g/mol to 6000 g/mol and based on propylene oxide and/or ethylene oxide, for the preparation of the crosslinking component (ii). The polyetherdiols and/or polyethertriols may be propoxylated diols and/or triols, but it is also possible to use ethoxylated diols and/or triols or mixed polyetherdiols and/or polyethertriols, it being possible for the alkylene oxides to be arranged blockwise or randomly in the polyetheralcohol. The expression “nominal” relating to the functionality with respect to isocyanates is to be understood as meaning that the initiator for the preparation of the polyetheralcohols has this number of functions reactive toward isocyanates, preferably hydroxyl groups. Owing to the alkoxylation of the initiator, the actual average functionality of the polyetheralcohols is usually lower. Alternatively or in addition to the feature “nominal functionality”, it is also possible to state the average actual functionality, which in the present case is preferably from 1.6 to 2.9. The polyetheralcohols (b2) may be a mixture of polyetheralcohols, the mixture having the characteristics according to the invention (e.g. functionality of from 2 to 3 and molecular weight of from 1500 to 6000 g/mol). In the polyetheralcohol (b2), ethylene oxide units are preferably arranged terminally.

Generally known diols having a corresponding molecular weight, for example ethylene glycol, propylene glycol, diethylene glycol, dipropylene glycol, triethylene glycol, tripropylene glycol, butane-1,4-diol or hexane-1,6-diol, preferably butane-1,4-diol and/or ethylene glycol, can be used as (c2) diols, i.e. as chain extenders preferably having a molecular weight of from 62 g/mol to 499 g/mol, for the preparation of the crosslinking component (ii).

Hollow cylindrical moldings in which the crosslinking component (ii) comprises heptane, n-pentane, 2-methylbutane and/or cyclopentane as preferably physical blowing agent (f) are particularly preferred. As a result of the additional blowing effect (in addition to water (d) according to the invention), it is ensured that even overload springs and/or moldings having a complex shape and densities of from 300 to 450 g/l are uniformly foamed.

The cylindrical, preferably hollow moldings according to the invention preferably have a height of from 25 mm to 1000 mm, particularly preferably from 25 mm to 200 mm, a maximum external diameter of from 40 mm to 700 mm, particularly preferably from 40 mm to 150 mm, and a minimum diameter of the cavity of from 0 mm to 90 mm, particularly preferably from 8 mm to 35 mm.

The cylindrical, preferably hollow moldings according to the invention preferably have a glass transition temperature of less than −33° C., particularly preferably −40° C. (ISO 6721-7, 1 Hz measuring frequency, heating rate 2° C./min, maximum of the loss modulus G″ₘₐₓ).

The cylindrical, preferably hollow moldings according to the invention preferably have a Shore A surface hardness according to DIN 53505-A of from 30 to 80, preferably from 40 to 65, at a density of 500 g/l.

The moldings according to the invention, i.e. the cellular polyisocyanate polyadducts, preferably the microcellular polyurethane elastomers, accordingly not only have excellent mechanical and dynamic properties, but in particular the stability in a humid warm climate could be substantially improved according to the invention, with good low-temperature flexibility. In particular, this combination of particularly advantageous properties could not be achieved to date in this form.

Preferably, in a two-stage process, the prepolymer (i) having isocyanate groups is prepared in the first stage by reacting (a) diisocyanatodiphenylmethane (MDI) with (b1) at least one polyetherdiol having a molecular weight of from 1500 g/mol to 3000 g/mol and based on ethylene oxide and/or propylene oxide, and (c1) at least one diol, preferably glycol, preferably dipropylene glycol and/or tripropylene glycol, in particular tripropylene glycol, and this prepolymer (i) is reacted in the second stage in a mold with the crosslinking component (ii).

The prepolymer (i) is preferably based on diisocyanatodiphenylmethane (MDI) and isocyanates which have carbodiimide structures and/or uretonimine structures.

Regarding the starting components present in the reaction mixture according to the invention, the following may additionally be mentioned:

According to the invention, diphenylmethane 2,2′-, 2,4′- and/or 4,4′-diisocyanate (MDI) is used as isocyanate (a), for example MDI comprising from 75 to 85% by weight, preferably 80% by weight, of methylenediphenyl 4,4′-diisocyanate and from 15 to 25% by weight, preferably 20% by weight, of methylenediphenyl 2,4′-diisocyanate. The MDI can, if appropriate, be used in modified form. If appropriate, further generally known (cyclo)aliphatic and/or aromatic polyisocyanates can be used in addition to the MDI. Aromatic diisocyanates, preferably naphthylene 1,5-diisocyanate (NDI), toluene 2,4- and/or 2,6-diisocyanate (TDI), dimethyldiphenyl 3,3′-diisocyanate, diphenylethane 1,2-diisocyanate or p-phenylene diisocyanate, and/or (cyclo)aliphatic isocyanates, such as, for example, hexamethylene 1,6-diisocyanate or 1-isocyanato-3,3,5-trimethyl-5-isocyanatomethylcyclohexane, and/or polyisocyanates, such as, for example, polyphenylpolymethylene polyisocyanates, are particularly suitable. The isocyanates can be used in the form of the pure compound, in mixtures and/or in modified form, for example in the form of uretdiones, isocyanurates, allophanates or biurets, preferably in the form of reaction products comprising urethane groups and isocyanate groups, so-called isocyanate prepolymers.

From this document, alcohols having from 1 to 8 hydroxyl groups and a molecular weight of from 500 g/mol to 8000 g/mol are designated by definition as compounds (b) reactive toward isocyanates. The above-described polyetheralcohols (b1) in the prepolymer (i) and (b2) in the crosslinking component (ii) are used as compounds (b) reactive toward isocyanates. These can, if appropriate, be used together with generally known polyhydroxy compounds, preferably polyetheralcohols and/or polyesteralcohols, particularly preferably polyetheralcohols, preferably those having a functionality with respect to isocyanate groups of from 2 to 3 and preferably a molecular weight of from 1500 to 6000 g/mol. The amount by weight of the polyetherdiols (b1) having a molecular weight of from 1500 g/mol to 3000 g/mol and based on propylene oxide and/or ethylene oxide based on the total weight of the compounds (b) reactive toward isocyanates and used for the preparation of the prepolymer (i) is preferably at least 70% by weight, particularly preferably at least 80% by weight, in particular at least 95% by weight, based in each case on the total weight of the compounds (b) reactive toward isocyanates and used for the preparation of the prepolymer. The amount by weight of the polyetheralcohols (b2) having a nominal functionality with respect to isocyanates of from 2 to 3 and a molecular weight of from 1500 g/mol to 6000 g/mol and based on propylene oxide and/or ethylene oxide based on the total weight of the compounds (b) reactive toward isocyanates and used in the crosslinking component (ii) is preferably at least 60% by weight, particularly preferably at least 70% by weight, in particular at least 80% by weight, based in each case on the total weight of the compounds reactive toward isocyanates in the crosslinking component (ii). Particularly preferably, exclusively the polyetheralcohols (b1) and (b2) according to the invention are used as component (b).

In addition to the above-described components (c1) and (c2) reactive toward isocyanates; it is furthermore possible to use chain extenders and/or crosslinking agents (c) having a molecular weight of less than 500 g/mol, preferably from 62 g/mol to 499 g/mol, for example selected from the group consisting of the di- and/or trifunctional alcohols, di- to tetrafunctional polyoxyalkylenepolyols and the alkyl-substituted aromatic diamines or of mixtures of at least two of said chain extenders and/or crosslinking agents. For example, alkanediols having 2 to 12, preferably 2, 4 or 6, carbon atoms can be used as (c), e.g. ethane-, 1,3-propane-, 1,5-pentane-, 1,6-hexane-, 1,7-heptane-, 1,8-octane-, 1,9-nonane- and 1,10-decanediol and preferably 1,4-butanediol, dialkylene glycols having 4 to 8 carbon atoms, such as, for example, diethylene glycol and dipropylene glycol and/or di- to tetrafunctional polyoxyalkylenepolyols. However, branched and/or unsaturated alkanediots having, usually, not more than 12 carbon atoms, are also suitable, such as, for example, 1,2-propanediol, 2-methyl- and 2,2-dimethylpropane-1,3-diol, 2-butyl-2-ethylpropane-1,3-diol, but-2-ene-1,4-diol and but-2-yne-1,4-diol, diesters of terephthalic acid with glycols having 2 to 4 carbon atoms, such as, for example, bis(ethylene glycol) or bis-1,4-butanediol terephthalate, hydroxyalkylene ethers of hydroquinone or of resorcinol, such as, for example, 1,4-di(β-hydroxyethyl)hydroquinone or 1,3-di(β-hydroxyethyl)resorcinol, alkanolamines having 2 to 12 carbon atoms, such as, for example, ethanolamine, 2-aminopropanol and 3-amino-2,2-dimethylpropanol, N-alkyldialkanolamines, such as, for example, N-methyl- and N-ethyldiethanolamine. Trifunctional alcohols and alcohols having a higher functionality, such as, for example, glycerol, trimethylolpropane, pentaerythritol and trihydroxycyclohexanes, and trialkanolamines, such as, for example, triethanolamine, may be mentioned by way of example as crosslinking agents (c) having a higher functionality. Alkyl-substituted aromatic polyamines having molecular weights of, preferably, from 122 to 400, in particular primary aromatic diamines which have, in the ortho position relative to the amino groups, at least one alkyl substituent which reduces the reactivity of the amino group by steric hindrance, which are liquid at room temperature and are at least partly but preferably completely miscible with the higher molecular weight, preferably at least difunctional compounds (b) under the processing conditions, have proven to be excellent as chain extenders and are therefore preferably used. For the production of the moldings according to the invention, the industrially readily obtainable 1,3,5-triethyl-2,4-phenylenediamine, 1-methyl-3,5-diethyl-2,4-phenylenediamine, mixtures of 1-methyl-3,5-diethyl-2,4- and -2,6-phenylenediamines, so-called DETDA, isomer mixtures of 3,3′-di- or 3,3′,5,5′-tetraalkyl-substituted 4,4′-diaminodiphenylmethanes having 1 to 4 carbon atoms in the alkyl radical, in particular 3,3′,5,5′-tetraalkyl-substituted 4,4′-diaminodiphenylmethanes comprising methyl, ethyl and isopropyl radicals in bound form and mixtures of said tetraalkyl-substituted 4,4′-diaminodiphenylmethanes and DETDA can be used. For achieving special mechanical properties, it may also be expedient to use the alkyl-substituted aromatic polyamines as a mixture with the abovementioned low molecular weight polyhydric alcohols, preferably dihydric and/or trihydric alcohols or dialkylene glycols.

According to the invention, the preparation of the cellular polyisocyanate polyadducts is preferably carried out in the presence of water (d). The water both acts as a crosslinking agent with formation of urea groups and, owing to the reaction of isocyanate groups with formation of carbon dioxide, as a blowing agent. Because of this dual function, it is mentioned in this document separately from (c) and (f). By definition, the components (c) and (f) therefore comprise no water which by definition is mentioned exclusively as (d). The amounts of water which can expediently be used are from 0.01 to 3% by weight, preferably from 0.1 to 0.6% by weight, based on the weight of the crosslinking component (ii).

For accelerating the reaction, generally known catalysts (e) may be added to the reaction batch both in the preparation of a prepolymer and, if appropriate, in the reaction of a prepolymer with a crosslinking component. The catalysts (e) can be added individually and also as a mixture with one another. Preferably, they are organometallic compounds, such as tin(II) salts of organic carboxylic acids, e.g. tin(II) dioctanoate, tin(II) dilaurate, dibutyltin diacetate and dibutyltin dilaurate, and tertiary amines, such as tetramethylethylenediamine, N-methylmorpholine, diethylbenzylamine, triethylamine, dimethylcyclohexylamine, diazobicyclooctane, N,N′-dimethylpiperazine, N-methyl, N′-(4-N-dimethylamino-)butylpiperazine, N,N,N′,N″,N″-pentamethyldiethylenediamine or the like. The following are furthermore suitable as catalysts: amidines, such as, for example, 2,3-dimethyl-3,4,5,6-tetrahydropyrimidine, tris(dialkylaminoalkyl)-s-hexahydrotriazines, in particular tris(N,N-dimethylaminopropyl)-s-hexahydrotriazine, tetraalkylammonium hydroxides, such as, for example, tetramethylammonium hydroxide, alkali metal hydroxides, such as, for example, sodium hydroxide, and alkali metal alcoholates, such as, for example, sodium methylate and potassium isopropylate, and alkali metal salts of long-chain fatty acids having 10 to 20 carbon atoms and, if appropriate, OH side groups. The catalysts (e) are used in amounts of from 0.001 to 0.5% by weight, based on the crosslinking component (ii), depending on the reactivity to be established.

If appropriate, conventional blowing agents (f) can be used in the polyurethane preparation. For example, low-boiling liquids which vaporize under the influence of the exothermic polyaddition reaction are suitable. Liquids which are inert to the organic polyisocyanate and have boiling points below 100° C. are suitable. Examples of such preferably used liquids are halogenated, preferably fluorinated, hydrocarbons, such as, for example, methylene chloride and dichloromonofluoromethane, perfluorinated or partly fluorinated hydrocarbons, such as, for example, trifluoromethane, difluoromethane, difluoroethane, tetrafluoroethane and heptafluoropropane, carbon dioxide, hydrocarbons, such as, for example, n-butane and isobutane, n-pentane and isopentane, and the industrial mixtures of these hydrocarbons, propane, propylene, hexane, heptane, cyclobutane, cyclopentane and cyclohexane, dialkyl ethers, such as, for example, dimethyl ether, diethyl ether and furan, carboxylic esters, such as, for example, methyl and ethyl formate, ketones, such as, for example, acetone, and/or fluorinated and/or perfluorinated, tertiary alkylamines, such as, for example, perfluorodimethylisopropylamine. Mixtures of these low-boiling liquids with one another and/or with other substituted or unsubstituted hydrocarbons may also be used. Other suitable blowing agents are physical blowing agents comprising thermoplastic spheres, for example those which are available on the market under the brand Expancell®. n-Pentane and/or isopentane and/or cyclopentane are preferably used as blowing agent (f). The most expedient amount of low-boiling liquid for the preparation of such cellular resilient moldings from elastomers comprising urethane and urea groups depends on the density which it is intended to achieve and the amount of water (d) according to the invention. In general, amounts of from 0.5 to 10% by weight, preferably from 1 to 5% by weight, based on the weight of the crosslinking component (ii), give satisfactory results. Particularly preferably, exclusively water (d) is used as the blowing agent, particularly if the components (i) and (ii) are introduced into the mold by means of a high pressure machine. If the shaped articles according to the invention are produced by means of the low pressure technique, physical blowing agents, preferably carbon dioxide, n-pentane, 2-methylbutane and/or cyclopentane, are preferably used in addition to the water.

Assistants (g) can be used in the production, according to the invention, of the shaped articles. These include, for example, generally known surface-active substances, foam stabilizers, cell regulators, fillers, flameproofing agents, nucleating agents, antioxidants, stabilizers, lubricants and mold release agents, dyes and pigments. Suitable surface-active substances are, for example, compounds which serve for promoting the homogenization of the starting materials and, if appropriate, are also suitable for regulating the cell structure. For example, emulsifiers, such as, for example, the sodium salts of castor oil sulfates or of fatty acids and salts of fatty acids with amines, for example of oleic acid with diethylamine, of stearic acid with diethanolamine and of ricinoleic acid with diethanolamine, salts of sulfonic acids, for example alkali metal or ammonium salts of dodecylbezene- or dinaphthylmethanedisulfonic acid and ricinoleic acid; foam stabilizers, such as siloxanefoxyalkylene copolymers and other organosiloxanes, oxyethylated alkylphenols, oxyethylated fatty alcohols, liquid paraffins, castor oil esters or ricinoleic esters, turkey red oil and peanut oil, and cell regulators, such as paraffins, fatty alcohols and dimethylpolysiloxanes, may be mentioned. For improving the emulsifying effect, the cell structure and/or the stabilization thereof, oligomeric polyacrylates having polyoxyalkylene and fluoroalkane radicals as side groups are furthermore suitable. The surface-active substances are usually used in amounts of from 0.01 to 5 parts by weight, based on 100 parts by weight of crosslinking component (ii).

Fillers, in particular reinforcing fillers, are to be understood as meaning the conventional organic and inorganic fillers, reinforcing agents and weighting agents known per se. The following may be mentioned specifically by way of example: inorganic fillers, such as silicate minerals, for example sheet silicates, such as antigorite, serpentine, hornblends, amphiboles, chrysotile and talc; metal oxides, such as kaolin, aluminas, aluminum silicate, titanium oxides and iron oxides, metal salts, such as chalk, barite and inorganic pigments, such as cadmium sulfide, zinc sulfide and glass particles. Examples of organic fillers are: carbon black, melamine, expanded graphite, rosin, cyclopentadienyl resins and graft polymers. Preferably used reinforcing fillers are fibers, for example carbon fibers or glass fibers, particularly when a high heat distortion resistance or very high rigidity is required, it being possible for the fibers to be treated with adhesion promoters and/or sizes. The inorganic and organic fillers can be used individually or as mixtures and are incorporated into the crosslinking component (ii) usually in amounts of from 0.5 to 50% by weight, preferably from 1 to 20% by weight.

Suitable flameproofing agents are, for example, tricresyl phosphate, tris(2-chloroethyl) phosphate, tris(2-chloropropyl) phosphate, tris(1,3-dichloropropyl) phosphate, tris(2,3-dibromopropyl) phosphate and tetrakis(2-chloroethyl)ethylene diphosphate. In addition to the abovementioned halogen-substituted phosphates, inorganic flameproofing agents, such as red phosphorus, hydrated alumina, antimony trioxide, arsenic trioxide, ammonium polyphosphate and calcium sulfate, or cyanuric acid derivatives, such as, for example, melamine, or mixtures of at least two flameproofing agents, such as, for example, ammonium phosphates and melamine, and, if appropriate, starch and/or expanded graphite for flameproofing the cellular PU elastomers prepared according to the invention can also be used. In general, it has proven expedient to use from 1 to 10% by weight in the cylindrical molding.

For example, talc, calcium fluoride, sodium phenylphosphinate, alumina and finely divided polytetrafluoroethylene in amounts of up to 5% by weight, based on the total weight of the cylindrical molding, can be used as a nucleating agent. Suitable antioxidants and heat stabilizers which can be added to the cellular PU elastomers according to the invention are, for example, halides of metals of group I of the Periodic Table of the Elements, for example sodium, potassium and lithium halides, if appropriate in combination with copper(I) halides, e.g. chlorides, bromides or iodides, sterically hindered phenols, hydroquinones and substituted compounds of these groups and mixtures thereof, which are preferably used in concentrations of up to 1% by weight, based on the total weight of the cylindrical molding.

Lubricants and mold release agents, which as a rule are likewise added in amounts of up to 1% by weight, based on the total weight of the cylindrical molding, are stearic acid, stearyl alcohol, stearic esters and stearamides and the fatty acid esters of pentaerythritol. Furthermore, organic dyes, such as nigrosine, pigments, such as, for example, titanium dioxide, cadmium sulfide, cadmium sulfide selenide, phthalocyanines, ultramarine blue or carbon black, may be added.

Further information on the abovementioned other conventional assistants and additives are to be found in the technical literature.

The cylindrical, preferably hollow moldings according to the invention, also referred to below as “moldings”, are used as damping elements in vehicle construction, for example in automotive construction, for example as overload springs, buffers, transverse link bearings, rear axle subframe bearings, stabilizer bearings, longitudinal strut bearings, suspension strut bearings, shock absorber bearings, bearings for short and long arm suspensions and/or as an emergency wheel which is present on the rim and, for example in the case of tire damage, ensures that the vehicle runs on the cellular polyisocyanate polyadduct and remains steerable.

The expression “cylindrical” is to be understood as meaning not only moldings which have a circular base area and a constant radius over the height but also moldings which have an oval cross section and/or an oval base area. Moldings in which only sections along the longitudinal axis have a round or oval cross section are also included by definition in the expression “cylindrical” in this document. Moldings in which the radius varies over the length, i.e. where the molding has constrictions and/or bulges, are also covered by this term “cylindrical”. Cylindrical moldings which have a round cross section are preferred.

In this document, the expression “hollow” molding is to be understood by definition as meaning those moldings which have a cavity along the longitudinal axis, preferably concentrically along the longitudinal axis. Preferably, the expression “hollow” is to be understood as meaning that a continuous, preferably concentric cavity is present in the molding along the entire longitudinal axis of the molding.

The invention is to be explained in more detail by the following examples.

### EXAMPLES

A high pressure machine from Krauss Maffei, type ECO II, having an MK ⅝ deflection-type mixing head was used for the experiments employing the high pressure technology. Here, the molds were filled with a mixing head output of 15-60 g/s. The inner surface of the molds had a temperature of 40-90° C. The components were mixed in the ⅝ deflection-type mixing head by means of specially tailored nozzles in which pressures of 140-200 bar were reached. The production of the shaped articles was carried out at an NCO/OH ratio of from 0.85 to 1.2 (=index). The mixing head outflow temperatures of the mixed components were 40-60° C. After filling of the mold, the mold was closed for foaming and completion of reaction. After 5-20 minutes, the molding could be removed from the mold.

The comparative experiments with the low pressure technology were effected on the casting machine side with a product constructed by Elastogran and with a specially modified F6 mixing head from Krauss Maffei (formerly EMB). Here, the molds were filled with a mixing head output of 15-60 g/s. The inner surface of the molds had a temperature of 40-90° C. The mixing of the components was effected in the mixing chamber using a dynamic stirring system at rotational speeds of 1000-6000 min⁻¹. The components were metered in at pressures of 2-20 bar. The production of the shaped articles was carried out at an NCO/OH ratio of from 0.85 to 1.2 (=index). The mixing head outflow temperatures of the mixed components were 40-60° C. After filling of the mold, the mold was closed for foaming and completion of reaction. After 5-20 minutes, the molding could be removed from the mold.

The following formulation was foamed by means of the high or low pressure technique described above.

Formulation 1 ( M̅(Polyol):3600 g/mol)

### 1) Preparation of the Prepolymer Containing NCO Groups

61.5 parts by weight of 4,4′-diisocyanatodiphenylmethane (Lupranat® MES from BASF Aktiengesellschaft) and 2 parts by weight of uretonimine-modified MDI (Lupranat® MM 103 from BASF Aktiengesellschaft) were melted under a nitrogen atmosphere in a three-necked flask, and a mixture of 4 parts by weight of tripropylene glycol and 32.5 parts by weight of a polypropylene oxide (propylene glycol as initiator molecule, hydroxyl number of 56 mg KOH/g, molecular weight 1970 g/mol) was added at 80° C. with stirring. The mixture was heated to 80° C. for 1 hour for complete reaction and then cooled. A virtually colorless liquid having an NCO content of 17.9% and a viscosity of 800 mPa·s at 25° C. resulted. The liquid had a shelf life of several weeks at room temperature.

### 2) Preparation of the Crosslinking Component:

46 parts by weight of polyoxypropylene (80% by weight)-polyoxyethylene (20% by weight) glycol having a hydroxyl number of 29 mg KOH/g and a molecular weight of 3410 g/mol, prepared using propylene glycol as an initiator molecule
37.6 parts by weight of polyoxypropylene (80% by weight)-polyoxyethylene (20% by weight) glycol having a hydroxyl number of 27 mg KOH/g and a molecular weight of 5180 g/mol, prepared using glycerol as an initiator molecule
12.2 parts by weight of 1,4-butanediol
0.3 part by weight of water
0.1 part by weight of dibutyltin dilaurate
0.3 part by weight of silicone-based foam stabilizer (DC 193 from Dow Corning)
1.9 parts by weight of a mixture of Lupragen® N 203 (BASF Aktiengesellschaft) and Niax® catalyst E-A-1 (GE Silicones), catalysts
1.6 parts by weight of cyclopentane

### 3) Production of the Cylindrical Molding

100 parts by weight of the prepolymer according to (1) were mixed with 114 parts by weight of the crosslinking component according to (2), the mixture was introduced into a closable mold (e.g. having the spring geometry according to FIG. 1) thermostated at 55° C. and the foam was cured for 12 min at 55° C. After the microcellular product had been removed from the mold, the shaped article was thermally postcured for 14 h at 95° C.

1-10. (canceled)

11. A process for preparing cellular polyurethane elastomers-based cylindrical moldings comprising reacting a prepolymer (i) comprising isocyanate groups with a crosslinking component (ii) in a mold, wherein said prepolymer (i) is based on methylenediphenyl diisocyanate and (b1) polyetherdiol having a molecular weight of from 1500 g/mol to 3000 g/mol and which is propylene oxide and/or ethylene oxide-based; wherein said crosslinking component (ii) comprises (b2) polyetheralcohol having a nominal functionality with respect to isocyanates of from 2 to 3, a molecular weight of from 1500 g/mol to 6000 g/mol and is propylene oxide and/or ethylene oxide-based, (c2) diol having a molecular weight of from 62 g/mol to 499 g/mol, (d) water, and (e) catalysts; wherein said prepolymer (i) and said crosslinking component (ii) are introduced into the mold by means of a high pressure machine which has a mixing head in which the components (i) and (ii) are mixed, wherein the output of said mixing head is from 15 to 60 g/s; and wherein said cellular polyurethane elastomers have a density, according to DIN EN ISO 1798, of from 350 to 800 kg/m³; a tensile strength, according to DIN EN ISO 1798, of greater than or equal to 2.0 N/mm²; an elongation, according to DIN EN ISO 1798, of greater than or equal to 200%; and a tear propagation resistance, according to DIN ISO 34-1 B, of greater than or equal to 8 N/mm.

12. The process of claim 11, wherein said components (i) and (ii) have a temperature of from 25° C. to 60° C. in each case in said mixing head.

13. The process of claim 11, wherein the outflow temperature of said mixing head is from 40° C. to 60° C.

14. The process of claim 11, wherein the inner surface of said mold has a temperature of from 40° C. to 90° C.

15. The process of claim 11, wherein said high pressure machine has an operating pressure of from 140 to 200 bar.

16. The process of claim 1, wherein said reaction is carried out at an NCO/OH ratio of prepolymer (i) to crosslinking component (ii) of from 0.85 to 1.2.

17. The process of claim 11, wherein the polyols (b) present in the cylindrical molding and comprising (b1) and (b2) have an average polyol molar mass of less than 4500 g/mol, the average polyol molar mass M̅(Polyol) being calculated according to the following formula:
$$\overline{M} ( Polyol ) = \frac{\begin{matrix}( {M}_{b 11} \cdot {m}_{b 11} + … + {M}_{b 1 n} \cdot {m}_{b 1 n} ) \cdot {W}_{b 1} + \\ ( {M}_{b 21} \cdot {m}_{b 21} + … + {M}_{b 2 n} \cdot {m}_{b 2 n} ) \cdot {W}_{b 2}\end{matrix}}{( {m}_{b 11} + … + {m}_{b 1 n} ) \cdot {W}_{b 1} + ( {m}_{b 21} + … + {m}_{b 2 n} ) \cdot {W}_{b 2}}$$
wherein
M̅(Polyol) is the average polyol molar mass;
M_{b11} (or M_{b1n}) is the molar mass of polyol b11 (or polyol b1n) in the prepolymer (i) in g/mol;
m_{b11} (or m_{b1n}) is the mass of polyol b11 (or polyol bin) in 100 g of prepolymer (i) in go;
W_{b1} is the mass fraction of the prepolymer (i) in the hollow cylindrical molding;
M_{b21} (or M_{b2n}) is the molar mass of polyol b21 (or polyol b2n) in the crosslinking component (ii) in g/mol;
m_{b21} (or m_{b2n}) is the mass of polyol b21 (or polyol b2n) in 100 g of crosslinking component (ii) in g; and
W_{b2} is the mass fraction of the crosslinking component (ii) in the hollow cylindrical molding.

18. The process of claim 11, wherein said prepolymer (i) is prepared by reacting (a) methylenediphenyl diisocyanate with (b1) polyetherdiols having a molecular weight of from 1500 g/mol to 3000 g/mol and are based on propylene oxide and/or ethylene oxide and with (c1) diol having a molecular weight of from 62 g/mol to 499 g/mol to form a prepolymer, wherein said prepolymer is subsequently reacted in a mold with crosslinking component (ii).

19. The process of claim 11, wherein said prepolymer (i) is based on methylenediphenyl diisocyanate and isocyanates comprising carbodiimide structures and/or uretonimine structures.

20. The process of claim 11, wherein said crosslinking component further comprises n-pentane, 2-methylbutane, and/or cyclopentane as blowing agent (f).
